(19) United States
(12) Patent Application Publication
(10) Pub. No.: US 2026/0346938 A1
(43) Pub. Date: Nov. 5, 2026

(54) BICYCLE ELECTRONIC CONTROL DEVICE

(71) Applicant: AD-II Engineering Inc., Taichung City (TW)

(72) Inventors: MENG-SIAN HUANG, Taichung City (TW); CHUNG-REN CHANG, Taichung City (TW); JYUN-HUA LIN, Taichung City (TW)

(21) Appl. No.: 19/194,397

(22) Filed: Apr. 30, 2025

(51) Int. Cl. B62J 45/00; B62K 23/06

(52) U.S. Cl. CPC B62J 45/00; B62K 23/06

(57) ABSTRACT

A bicycle electronic control device configured to be mounted on a handlebar of a bicycle, wherein the bicycle electronic control device includes: a handlebar seat including a grip portion; a brake lever disposed on the handlebar seat; a rotation shaft by which the brake lever is rotatably connected to the handlebar seat; an antenna unit disposed on the rotation shaft; and a control unit in communication with the antenna unit to transmit a wireless signal.

### BACKGROUND OF THE INVENTION

### Field of the Invention

The present invention relates to a control device, particularly to a bicycle electronic control device.

### Description of the Prior Art

Bicycles with variable speed capability are widely favored by consumers as their gear positions can be switched according to different pedaling requirements (such as flat roads, uphill, and downhill conditions).

Conventionally, the control of a bicycle derailleur is typically achieved by toggling a control lever installed near a brake lever or rotating a control disc to pull a cable, thereby actuating the bicycle derailleur to shift gears. In recent years, electronic control technology has been developed, where an electronic control device is installed on the handlebar of a bicycle and controlled by finger pressing. However, the wires connecting the electronic control device must be routed around the pivot portion of the brake lever, making installation inconvenient and causing the wires to be susceptible to wear and tear, thus reducing durability.

Furthermore, in the conventional electronic control technology, the control circuit is typically installed inside the handlebar seat, requiring modifications to the structure of the handlebar seat to accommodate the control circuit, which increases additional manufacturing costs. Some designs install the control circuit on the brake lever, which may result in unintended activation of the brake lever when operating the electronic control, causing inconvenience during riding.

The present invention is, therefore, arisen to obviate or at least mitigate the above-mentioned disadvantages.

### SUMMARY OF THE INVENTION

The main object of the present invention is to provide a bicycle electronic control device that does not require control wires to be routed on the bicycle frame to be connected to the controlled device, which has a simple and stable structure, is easy to install, and does not require modifications to structural designs, thereby facilitating operation.

To achieve the above and other objects, a bicycle electronic control device configured to be mounted on a handlebar of a bicycle, wherein the bicycle electronic control device includes: a handlebar seat including a grip portion; a brake lever disposed on the handlebar seat; a rotation shaft by which the brake lever is rotatably connected to the handlebar seat; an antenna unit disposed on the rotation shaft; and a control unit in communication with the antenna unit to transmit a wireless signal.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention.

FIG. 2 is an exploded view of an exemplary embodiment of the present invention.

FIG. 3 is a cross-sectional view of an exemplary embodiment of the present invention.

FIG. 4 is a partial enlarged cross-sectional view of an exemplary embodiment of the present invention.

FIG. 5 is a schematic diagram of an antenna unit in an exemplary embodiment of the present invention.

FIG. 6 is a perspective view of an antenna unit in another exemplary embodiment of the present invention.

FIG. 7 is a perspective view of an antenna unit in yet another exemplary embodiment of the present invention.

### DETAILED DESCRIPTION OF THE PREFERRED EMBODIMENT S

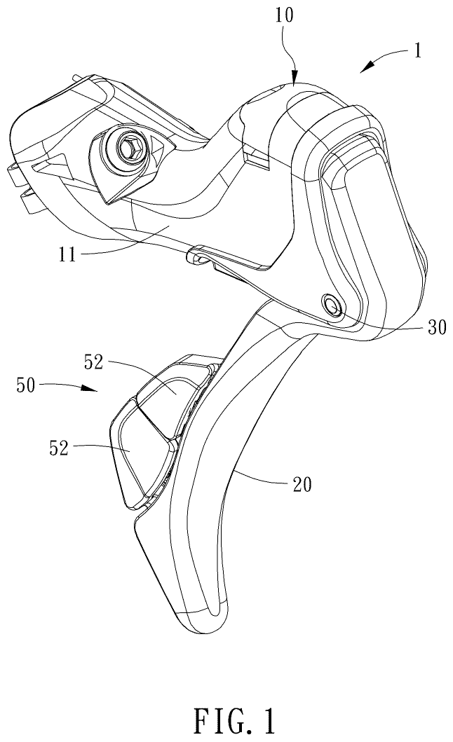

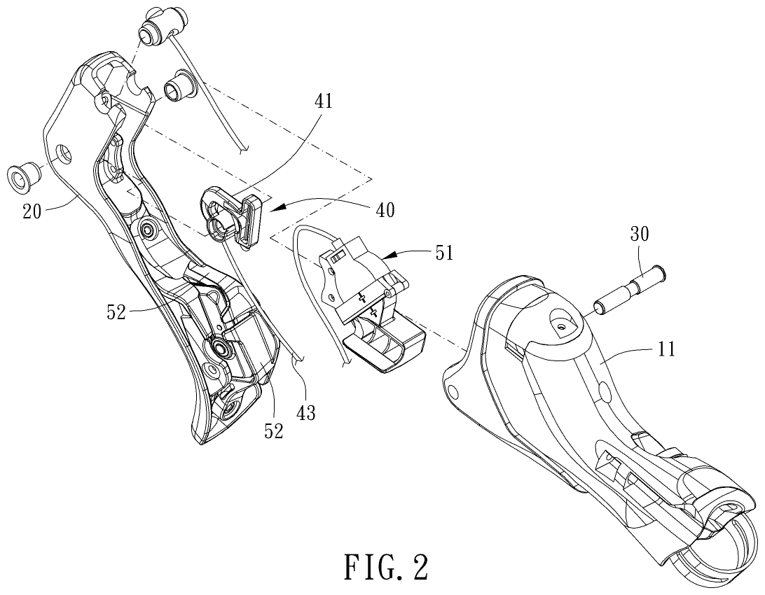

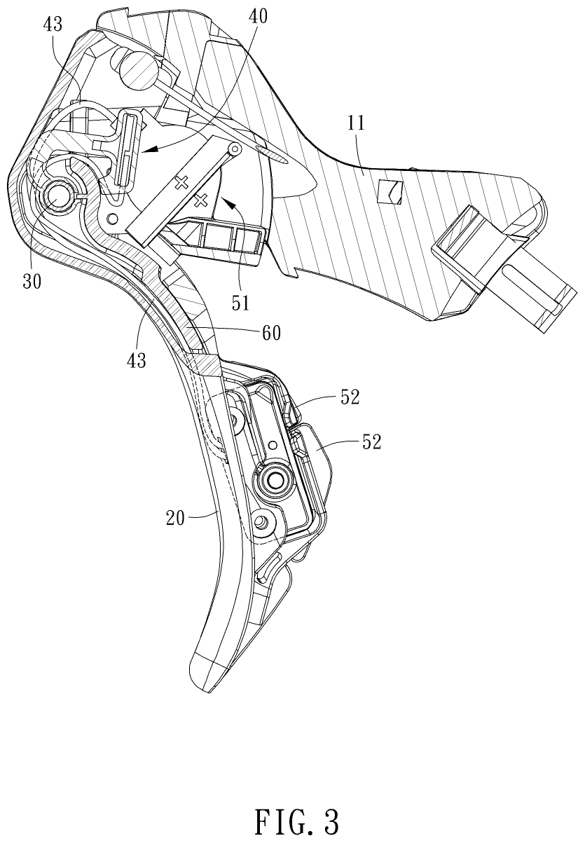

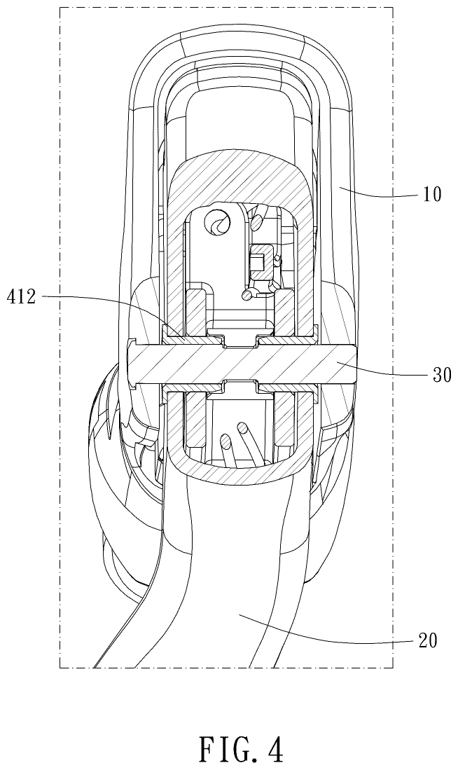

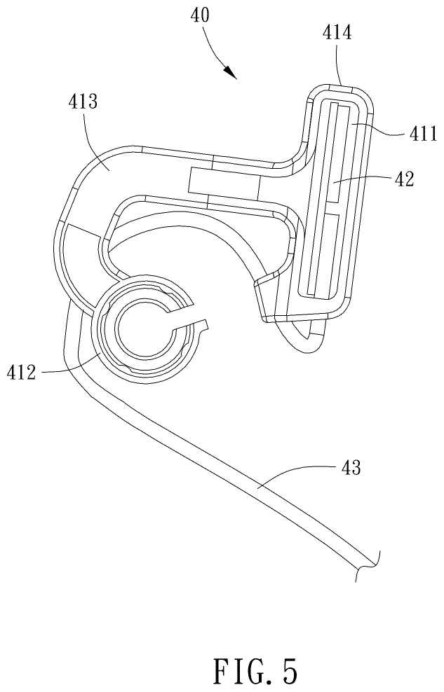

Please refer to FIGS. 1 to 5 for an exemplary embodiment of the present invention. A bicycle electronic control device 1 is configured to be mounted on a handlebar of a bicycle. The bicycle electronic control device 1 includes a handlebar seat 10, a brake lever 20, a rotation shaft 30, an antenna unit 40, and a control unit 50. The handlebar, for example, may be a bent handlebar.

The handlebar seat 10 includes a grip portion 11 for gripping by hand. The brake lever 20 is connected to the handlebar seat 10 and is configured to be operated to brake the bicycle. The brake lever 20 is rotatably connected to the handlebar seat 10 by the rotation shaft 30, allowing the brake lever 20 to rotate relative to the handlebar seat 10 during operation. The antenna unit 40 is disposed on the rotation shaft 30. The antenna unit 40 may be rotatably arranged relative to the rotation shaft 30, enabling the antenna unit 40 to remain stably positioned without being affected by the pivotal movement of the brake lever 20 and/or the rotation shaft 30, thereby preventing damage due to pulling forces. Alternatively, the antenna unit 40 may be arranged non-rotatably relative to the rotation shaft 30, providing structural stability and strength. The control unit 50 is in communication with the antenna unit 40 to transmit a wireless signal. Accordingly, there is no need to route control wires on the bicycle frame to be connected to the controlled device, ensuring a simple and stable structure that is easy to install and operate. The bicycle electronic control device 1 may be used to control a front derailleur and/or a rear derailleur for shifting gears, as well as other electronic components or devices of the bicycle.

The bicycle electronic control device 1 further includes a control lever 60 which is rotatably connected to the rotation shaft 30. The control unit 50 is disposed on the control lever 60. The control lever 60 is rotatable about the rotation shaft 30. For example, when the rider toggles the brake lever 20, the control lever 60 rotates simultaneously. Thus, when gear shifting control is desired, the rider can press the control unit 50 disposed on the control lever 60 using their fingers, providing excellent operational convenience.

In this embodiment, the antenna unit 40 is sleeved on the rotation shaft 30. The antenna unit 40 includes a base 41 disposed on the rotation shaft 30 and an antenna 42 disposed on the base 41. The antenna 42 is configured to transmit the wireless signal. Specifically, the control unit 50 includes a power 51 which is electrically connected to the antenna unit 40 and the control unit 50. The antenna 42, for example, is connected to the control unit 50 through a wire 43. The power 51 provides the necessary electrical energy for the operation of the antenna unit 40 and the control unit 50. The power 51 may be a primary battery or a secondary battery, and preferably a button battery which is compact, easy to obtain and convenient to install, replace and maintain.

Specifically, the base 41 includes a slot 411, and the antenna 42 is received in the slot 411. Preferably, the antenna 42 is not protrusive beyond the slot 411, ensuring good protection for the antenna 42. The base 41 further includes a sleeve portion 412, an arm 413 and an antenna mounting portion 414. The sleeve portion 412 is sleeved on the rotation shaft 30. The arm 413 is connected to and between the sleeve portion 412 and the antenna mounting portion 414. The antenna 42 is disposed on the antenna mounting portion 414, and the antenna mounting portion 414 includes the slot 411. The arm 413 enables appropriate configuration within different available spaces inside the handlebar seat.

The control unit 50 further includes at least one operation mechanism 52 configured to operate to transmit the wireless signal. The operation mechanism 52, for example, may be an electronic switch which may be a press-type or touch-screen type switch. The operation mechanism 52 is disposed on the control lever 60; however, the operation mechanism 52 may be disposed on the handlebar seat 10 or other positions, and it remains conveniently operable. In this embodiment, two operation mechanisms 52 (e.g., for upshifting and downshifting) are disposed on the control lever 60. The control lever 60 at least partially overlaps spatially with the brake lever 20, and the two operation mechanisms 52 are arranged along an outer contour of the brake lever 20 in a high-low arrangement, thereby offering excellent operational convenience.

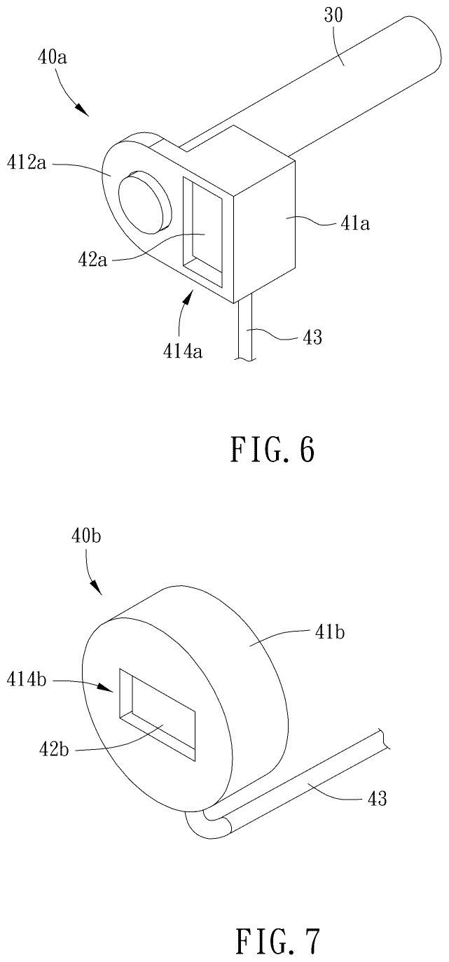

In an exemplary embodiment shown in FIG. 6, the base 41a of the antenna unit 40a includes a sleeve portion 412a sleeved on the rotation shaft 30, and an antenna mounting portion 414a connected to the sleeve portion 412a. The antenna 42a is received in the antenna mounting portion 414a and connected to the control unit via a wire 43. As such, the antenna unit 40a has a smaller size, making it suitable for installation in narrow spaces.

In another exemplary embodiment shown in FIG. 7, the base 41b of the antenna unit 40b is disposed on the rotation shaft. The antenna 42b is received in the antenna mounting portion 414b and connected to the control unit via a wire 43. The base 41b may be connected to the rotation shaft via a connecting component, or it may be directly connected (e.g., by clamping, inserting, or bonding) to the rotation shaft. As such, the antenna unit 40b has a compact size and a simple structure, and is convenient for installation, replacement and maintenance.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bicycle electronic control device configured to be mounted on a
handlebar of a bicycle, including:
a handlebar seat including a grip portion;
a brake lever disposed on the handlebar seat;
a rotation shaft by which the brake lever is rotatably connected to the handlebar seat;
an antenna unit disposed on the rotation shaft; and
a control unit in communication with the antenna unit to transmit a wireless signal.

2. The bicycle electronic control device of claim 1, further including a control lever, the control lever rotatably connected to the rotation shaft, and the control unit is disposed on the control lever.

3. The bicycle electronic control device of claim 1, wherein the control unit includes a power, and the power is electrically connected to the antenna unit and the control unit.

4. The bicycle electronic control device of claim 1, wherein the antenna unit is sleeved on the rotation shaft.

5. The bicycle electronic control device of claim 1, wherein the antenna unit includes a base connected to the rotation shaft and an antenna disposed on the base, and the antenna is configured to transmit the wireless signal.

6. The bicycle electronic control device of claim 5, wherein the base includes a slot, and the antenna is received in the slot.

7. The bicycle electronic control device of claim 5, wherein the base further includes a sleeve portion, an arm and an antenna mounting portion, the sleeve portion is sleeved on the rotation shaft, the arm is connected to and between the sleeve portion and the antenna mounting portion, and the antenna is disposed on the antenna mounting portion.

8. The bicycle electronic control device of claim 2, wherein the control unit includes an operation mechanism configured to operate to transmit the wireless signal.

9. The bicycle electronic control device of claim 8, wherein the operation mechanism is disposed on the control lever.

10. The bicycle electronic control device of claim 2, wherein two operation mechanisms are disposed on the control lever, the control lever and the brake lever at least partially overlap spatially, and the two operation mechanisms are arranged along an outer contour of the brake lever and in a high-low arrangement.
